(19) United States
(12) Patent Application Publication
(10) Pub. No.: US 2015/0317600 A1
(43) Pub. Date: Nov. 5, 2015

(54) REQUIREMENT-SPECIFIC CONFIGURATION OF USER INTERFACE FORMS

(71) Applicant: PINKI PACHISIA, Bangalore (IN)

(72) Inventor: PINKI PACHISIA, Bangalore (IN)

(21) Appl. No.: 14/265,376

(22) Filed: Apr. 30, 2014

(51) Int. Cl. G06Q 10/10

(52) U.S. Cl. CPC G06Q 10/10

(57) ABSTRACT

Various embodiments of systems and methods for form design are described herein. A user interface to configure a procurement-related non-catalogue form is displayed. The user interface includes configuring options that enable customization of form name, form category, and form fields. Configuration data is received in response to user input corresponding to the configuring options. The received configuration data is saved corresponding to the non-catalogue form. The saved configuration data is read for rendering the non-catalogue form.

### BACKGROUND

Organizations typically use software applications for their procurement needs. Procurement-related applications such as supplier relationship management applications are widely used nowadays for most, if not all, of the procurement needs. Procurement-related applications provide user interfaces using which several procurement activities such as raising purchase requests can be performed. Users of an organization can make purchase requests for goods or services through these user interfaces. However, such user interfaces have fixed fields which may not address organization-specific procurement needs. For example, the fixed fields of a user interface may be sufficient and appropriate for an organization, but some of the fixed fields may be irrelevant and confusing for another organization having different procurement needs.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a non-catalogue UI form, as an example.

FIG. 2 is a block diagram of a user interface to configure a non-catalogue form, according to one embodiment.

FIG. 3 is a block diagram of the configuring user interface displaying a first set of configuring fields, according to one embodiment.

FIG. 4 is a block diagram of the configuring user interface after saving entries in the first set of configuring fields, according to one embodiment.

FIG. 5 is a block diagram of the configuring user interface displaying a second set of configuring fields, according to one embodiment.

FIG. 6 is a block diagram of the configuring user interface displaying a code editor, according to one embodiment.

FIG. 7 is a block diagram of a procurement user interface 700, according to one embodiment.

FIG. 8 is a block diagram of a non-catalogue form for a first organization, according to one embodiment.

FIG. 9 is a block diagram of a non-catalogue form for a second organization, according to one embodiment.

FIG. 10 is a block diagram of the configuring user interface displaying categories in the process of modifying an existing non-catalogue form, according to one embodiment.

FIG. 11 is a block diagram of the configuring user interface displaying forms in a category in the process of modifying an existing non-catalogue form, according to one embodiment.

FIG. 12 is a block diagram of the configuring user interface displaying first set of configuring fields in the process of modifying an existing non-catalogue form, according to one embodiment.

FIG. 13 is a block diagram of the configuring user interface displaying second set of configuring fields in the process of modifying an existing non-catalogue form, according to one embodiment.

FIG. 14 is a block diagram of the configuring user interface displaying a code editor in the process of modifying an existing non-catalogue form, according to one embodiment.

FIG. 15 is a block diagram of a method of form design and display, according to one embodiment.

FIG. 16 is a block diagram of an exemplary computer system according to one embodiment.

### DETAILED DESCRIPTION

Embodiments of techniques for requirement-specific configuration of user interface forms are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-know structures, materials, or operations are not shown or described in detail.

Reference throughout this specification to “one embodiment”, “this embodiment” and similar phrases, means that a particular feature, structure, or characteristic described in connection with the embodiment is included al least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Procurement is an important activity for organizations. A variety of goods or services are procured by an organization. To efficiently manage procurement process, procurement-related applications such as supplier relationship management applications (SRM) are used. An SRM application provides user interfaces to manage procurement activities, among others. For example, purchase requests can be raised via a user interface (UI) of an SRM application. Some of the items to be procured can be readily available and can be part of a catalogue of items. A user can access such catalogue of items through the SRM application, select an item, and make a purchase request. In some cases, however, material, product, or service items may not be readily available in a catalogue. Such items can be referred to as non-catalogue items. Non-catalogue items have to be described when making a purchase request. A non-catalogue UT form can be used to describe non-catalogue items.

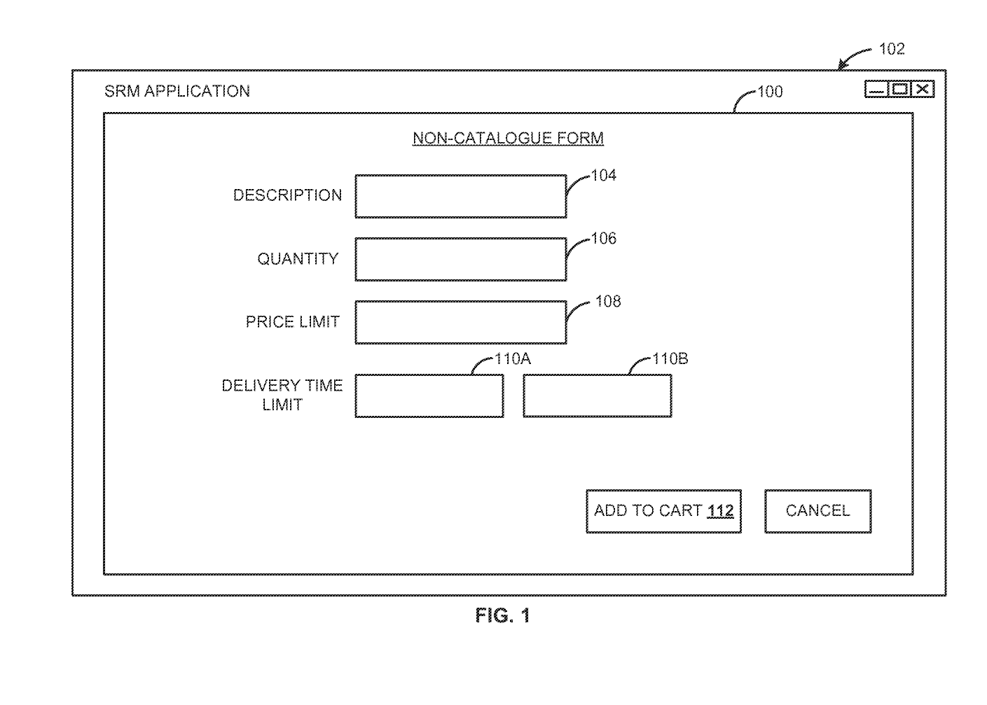

FIG. 1 illustrates a non-catalogue UT form 100, as an example. The non-catalogue form can be part of an SRM application 102. A user can log on to the SRM application 102 and access the non-catalogue form 100. The non-catalogue form 100 includes a plurality of fields that enable description of a non-catalogue item. For example, the fields can use an item description filed 104, quantity field 106, and limit fields 108, 110A and 110B. Description about the item to be procured can be entered in the item description filed 104 and the quantity of items to be procured can be entered in the quantity field 106. Limit fields can be used to provide various limits or upper/lower bounds related to the item. For example, the limit fields can include a price limit field 108 and delivery time limit fields 110B and 110B. A price limit field 108 can be used to provide the ceiling price for the item. Delivery timeframe can be provided using the delivery time limit fields 110A and 110B. A user can mention the delivery timeframe by providing two dates, in delivery time limit fields 110B and 110B, between which the item should be delivered. Following which, non-catalogue item can be added to cart using the add to cart option 112. It should be noted that the above mentioned fields in the non-catalogue form are provided as examples. Although not shown, there can be other fields in the non-catalogue form.

Fields in a typical non-catalogue form are fixed or come in as standard. The terminologies used in the non-catalogue UT form are also standard. Because organizations can have different preferences, fields and standard terminologies can be sometimes confusing and irrelevant. As an example, for some organizations, terminologies such as “Limit” in the context of a limit form. A limit form is a non-catalogue form which includes limit fields. As described previously, limit fields can be used to provide upper/lower bounds related to an item. For an organization ‘A,’ the terminology “Limit” may not be clear. As another example, an “expected value” field can be used to provide the expected price of an item. This “expected value” may not be clear to an organization ‘B.’ In some cases, an organization ‘C’ may need fields such as company code, purchasing group, or plant, which may not be present in a standard non-catalogue form. These examples illustrate that different organizations have different preferences and requirements and standard non-catalogue forms with fixed fields and terminologies do not address the diversity of preferences.

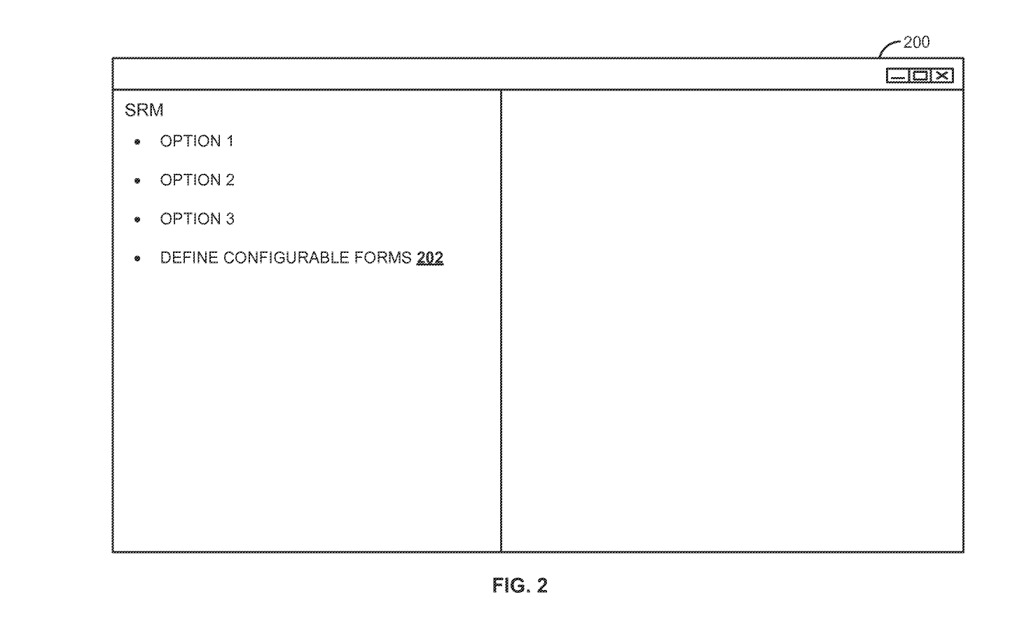

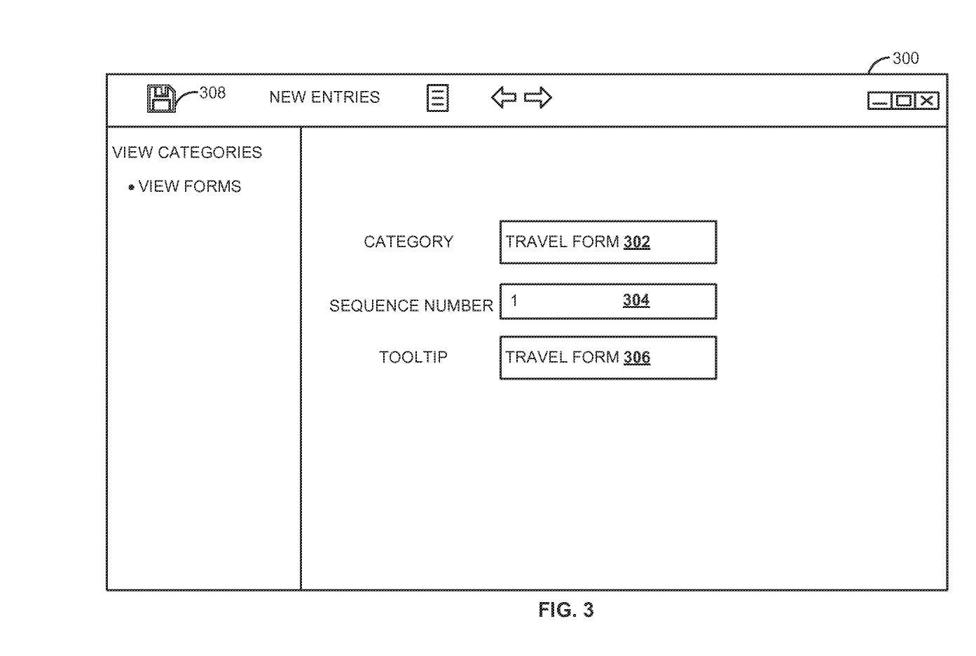

FIG. 2 illustrates a block diagram of a user interface 200 to configure an SRM system. There can be several options related to configuration of an SRM system. In one embodiment, the user interface 200 can be used by an organization to configure or customize a procurement-related non-catalogue form. A configuring user responsible for form design can access the user interface 200 and configure a non-catalogue form. An option 202 to initiate configuration is provided in the user interface 200. Upon selection of the option 202 by a configuring user, configuring options are displayed in a form-configuring user interface 300, as shown in FIG. 3. In one embodiment configuring options including a first set of configuring fields 302, 304, and 306 are displayed in the right-side portion of the user interface 300. A first configuring field 302 is used to assign a category or a section to anon-catalogue form that is to be created. Consider that an organization needs to create a new non-catalogue domestic travel form. A category “Travel Form” can be assigned to the domestic travel form to be created. The text “Travel Form” can be entered in the first configuring field 302. In a second configuring field 304 sequence number can be entered. Sequence number can refer to the order of the category in a list of categories that will be displayed to an end user such as a user making a purchase request. In a third configuring field 306, a tooltip can be entered. The entries made in the first, second, and third configuring fields 302, 304, and 306 are part of configuration data, which is received and then saved upon selecting a save option 308.

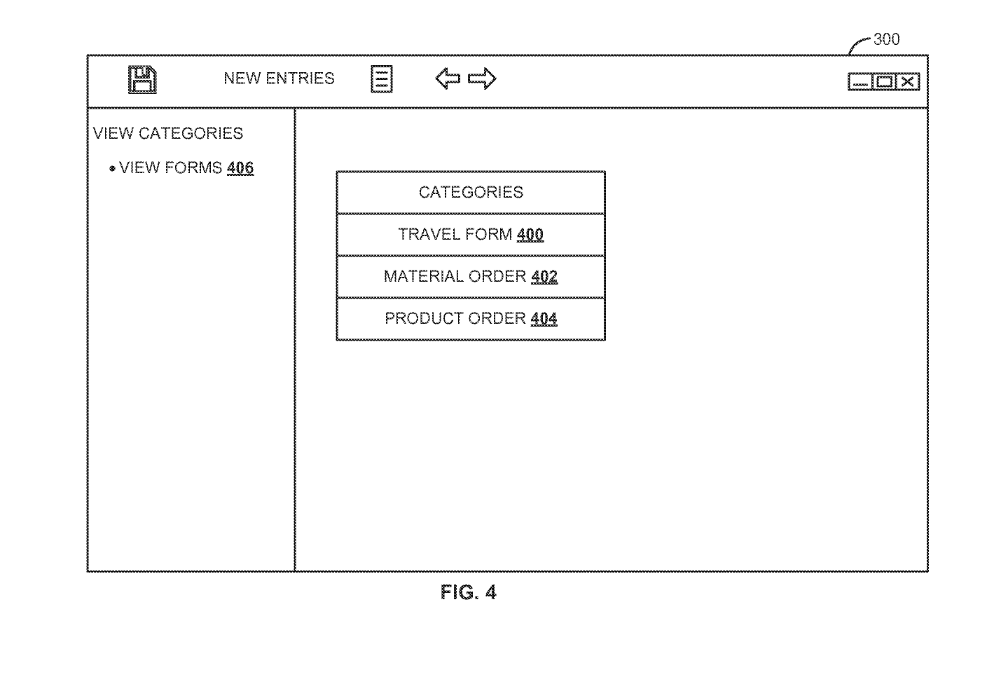

Referring to FIG. 4, the category “Travel Form” 400 is now listed in the configuring user interface 300, as shown in FIG. 4. The user interface 300 shows other categories such as material order 402 and product order 404, which indicate that these categories have been previously created. To further configure the domestic travel form, the category “Travel Form” 400 is selected, following which the option “View Forms” 406 is selected. Following these selections, a second set of configuring fields are displayed, as shown in 5. A fourth configuring field 500 can be used to name the domestic travel form. The text “Travel-domestic” can be entered in the fourth configuring field 500. As another example (not shown), “Travel-international” can be entered if an international travel form is to be created. In a fifth configuring field 502, a tool tip for the “Travel-domestic” form can be entered. In a sixth configuring field 504, a key is assigned to the “Travel-domestic” form. This key identifies the “Travel-domestic” form when the “Travel-domestic” form is to be rendered at the request of an end user. In a seventh configuring field 506, a sequence number can be entered. Sequence number can refer to the order of the form in a list of forms that will be displayed to an end user. The entries in the configuring fields 500-506 are also part of configuration data, which is received and then saved upon selecting the save option 308.

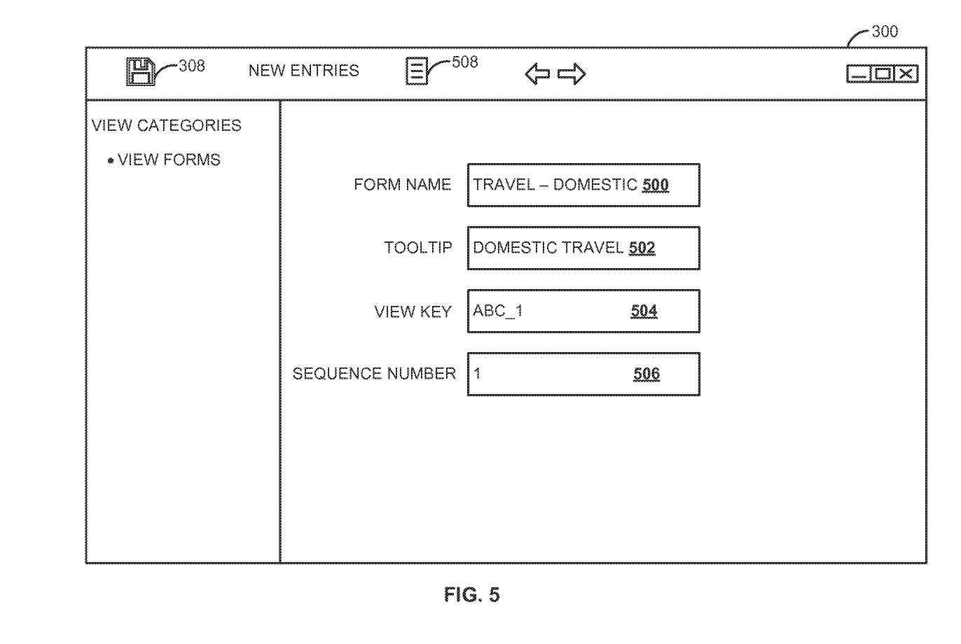

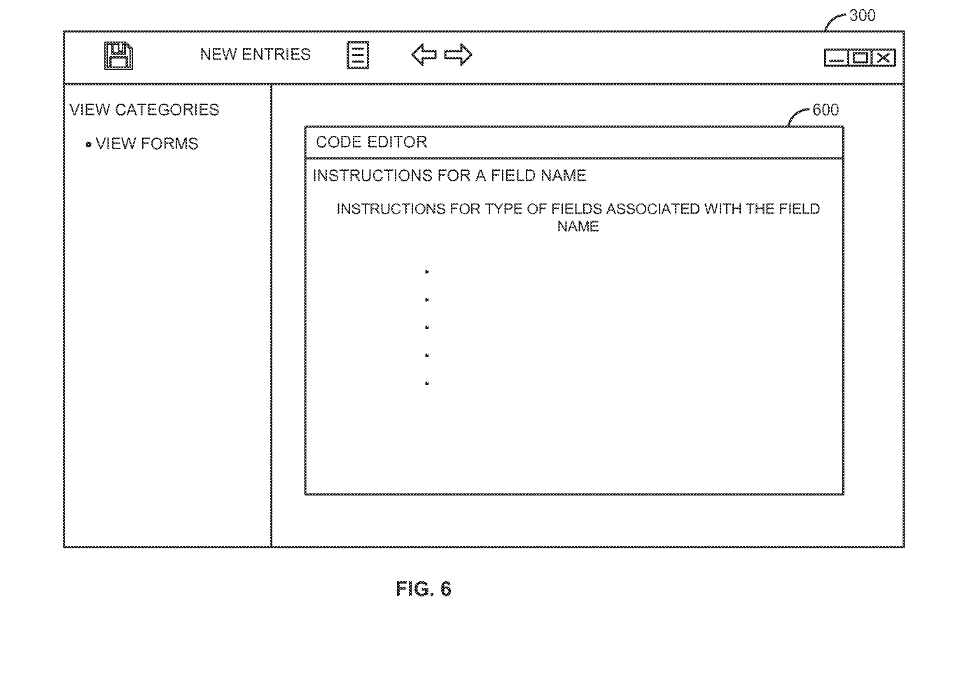

The configuring options further include a code editor. After entries in the configuring fields are saved, an icon 508 in the user interface can be selected to launch the code editor. In one embodiment, referring to FIG. 6, the code editor 600 can be launched in the user interface 300. In another embodiment, the code editor can be launched in a separate window. The name of the fields for “Travel-domestic” form, the type of fields such as limit fields, entry options, etc., can then be configured in the code editor 600. A configuring user can write instructions in a suitable language to design the form. In one embodiment, JAVASCRIPT is used to design the form. However, other programming languages such as scripting languages can be used to create forms that are accessible over the Internet or the Intranet. Instructions to name new form fields as per the preference of an organization, add non-limit fields, and add limit fields, etc., can then be entered in the code editor 600. A reference to the key associated with the “Travel-domestic” form is also included as an instruction. As described above, the key is entered in the sixth configuring field (FIG. 5). The instructions entered in the code editor 600 are also part of configuration data, which is received and then saved. This completes the configuration of the “Travel-domestic” form. An example set of instructions is presented below:

sap.ui.jsview(“<view name>”,{ getControllerName : function( ) {return
“<view name>”;},
createContent : function (oController) {
<<Instructions related to fields are entered here >>
},
})

The configuration data therefore includes the entries in the configuring fields and the instructions in the code editor 600. The configuration data is saved corresponding to the “Travel-domestic” form. This saved configuration data is read when the “Travel-domestic” form is to be rendered. In one embodiment, the configuration data can be stored locally at the customer or organization's site. In another embodiment, the configuration data be stored in a remote location and is accessible over a network when a corresponding form is to be rendered. Various types of forms can be designed using the user interface 300, i.e., by entering the category and form name details in configuring fields and entering instructions related to the form fields.

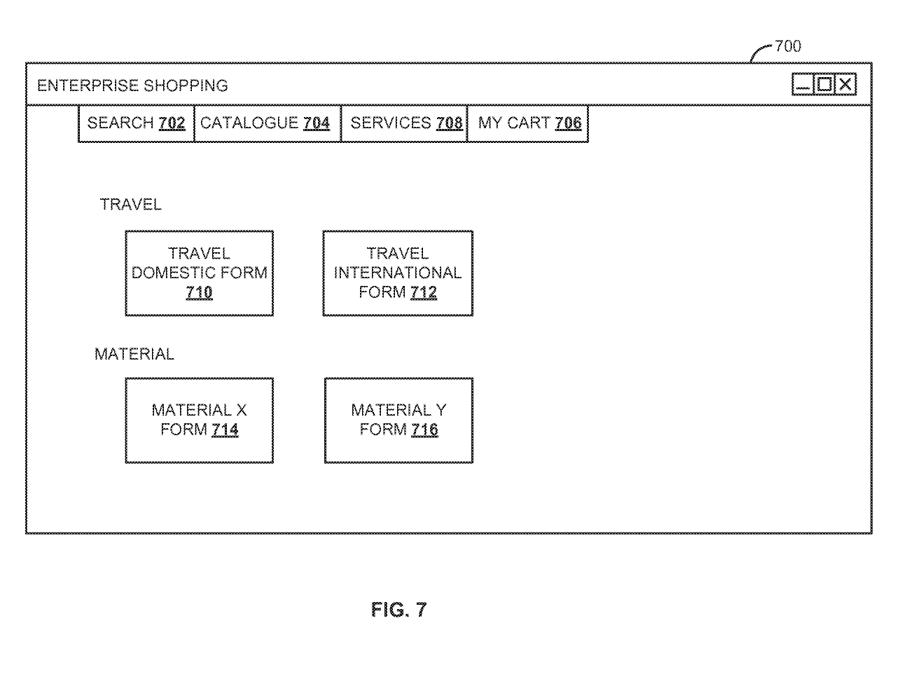

FIG. 7 illustrates a procurement user interface 700. Several procurement-related activities can be performed using the procurement user interface 700. For example, using the search option 702, non-catalogues forms can be searched. A catalogue can be opened using the catalogue option 704. Items for which procurement process has been initiated can be viewed by selecting my cart option 706. To display non-catalogue forms, services option 708 can be selected. In the procurement user interface 700, the services option 708 is selected and a list of available non-catalogue forms 710, 712, 714, and 716 is displayed. The non-catalogue forms 710-716 are created using the procedure described above in reference to FIGS. 2-6. The non-catalogue forms 710-716 are created as per the preferences and requirements of an organization by a configuring user of that organization. Therefore, users involved in procurement process can readily know the purpose of a form by looking at the form name and, if needed, a tooltip (not shown) related to the form.

The non-catalogue forms are divided into two categories, namely, travel and material. In the travel category, non-catalogue forms include “Travel-Domestic” form icon 710 and “Travel-International” form icon 712. In the material category, non-catalogue forms include “Material-X” form icon 714 and “Material-Y” form icon 716. These non-catalogue forms can be limit forms, but they are not named as such. Rather, organization-specific terminology is used for form name, for categories, and form fields. Also, the fields are configured based on the requirements of the organization. This avoids confusion for the procurement users and eliminates the need to decipher fixed terminologies and fixed fields. Upon selecting one of the form icons, a corresponding form is rendered. Consider that “Material-X” form icon 714 is selected. Following this selection, configuration data of the “Material-X” form is read and will be displayed in a new user interface.

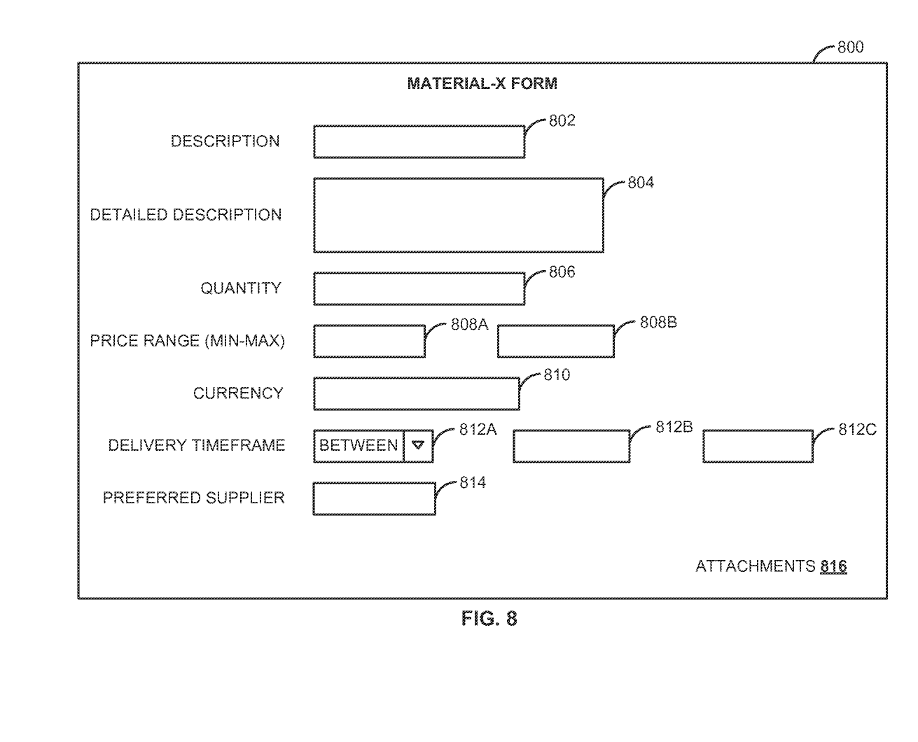

FIG. 8 illustrates a “Material-X” UI form 800, which is selected by a procurement user of a first organization. The form 800 includes a plurality of input fields, which correspond to the configuration data. In a material item description field 802, description of the material to be procured can be provided. For example, material name can be provided in the description field 802. A more detailed description about the material such as material characteristics, etc., can be provided in the detailed description field 804. The quantity of the required material can be provided in the quantity field 806. Expected price range can be provided in the price range fields 808A and 808B. A lower price limit can be provided in the lower limit field 808A and an upper price limit can be provided in the upper limit field 808B. Type of currency in which transaction should take place can be provided in the currency field 810. The delivery time frame can be provided using three fields. A first field 812A can be used to select “between” via a drop down menu, a second field 812B can be used to select a first date and a third field 812C can be used to select a second date. This means that the preferred delivery should be between the first date and the second date. Preferred supplier or suppliers can be provided in the preferred supplier field 814. Any attachments can be attached using the attachment option 816. Once the required details are entered, the form is saved and the procurement process is initiated.

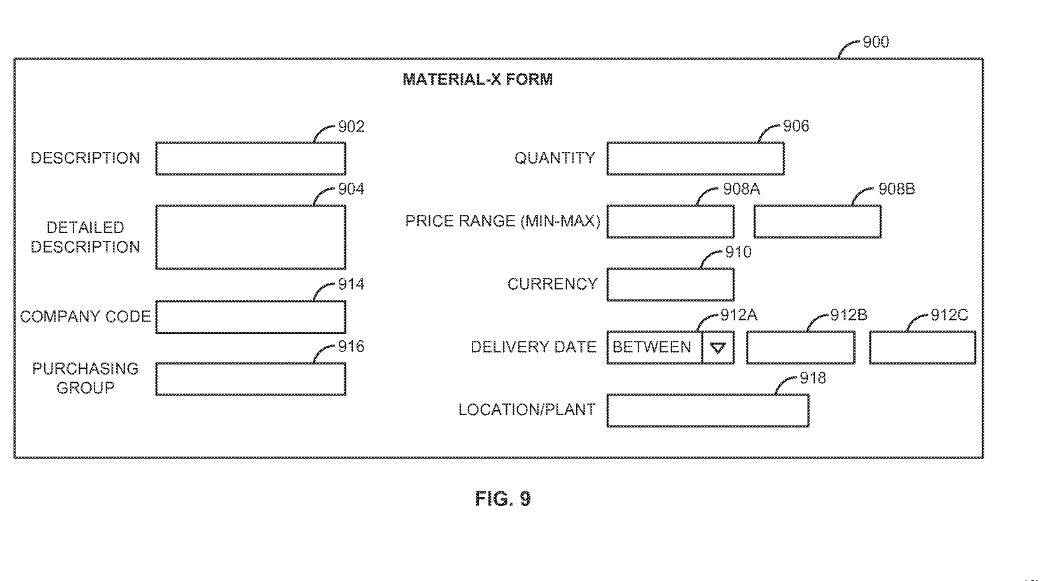

FIG. 9 illustrates a “Material-X” UI form 900 as configured according to preferences of a second organization. This form 900 includes item description field 902, detailed description field 904, quantity field 906, price range fields 908A and 908B, currency field 910, and delivery time frame fields 912A, 91213, and 912C. The form further includes a company code field 914, a purchasing group field 916, and a location/plant field 918. Unlike the first organization, the second organization may prefer having company code field, a purchasing group field, and a location/plant field. Therefore, the form can be accordingly configured in view of preferences of the second organization. The company code can be entered or pre-populated in the company code field 914. The department which is making the purchase can be entered in the purchasing group field 916 or auto-populated based on the purchasing user's line of business. The location or plant at which the material should be delivered can be entered in location/plant field 918. Once the required details are entered, the form is saved and the procurement process is initiated.

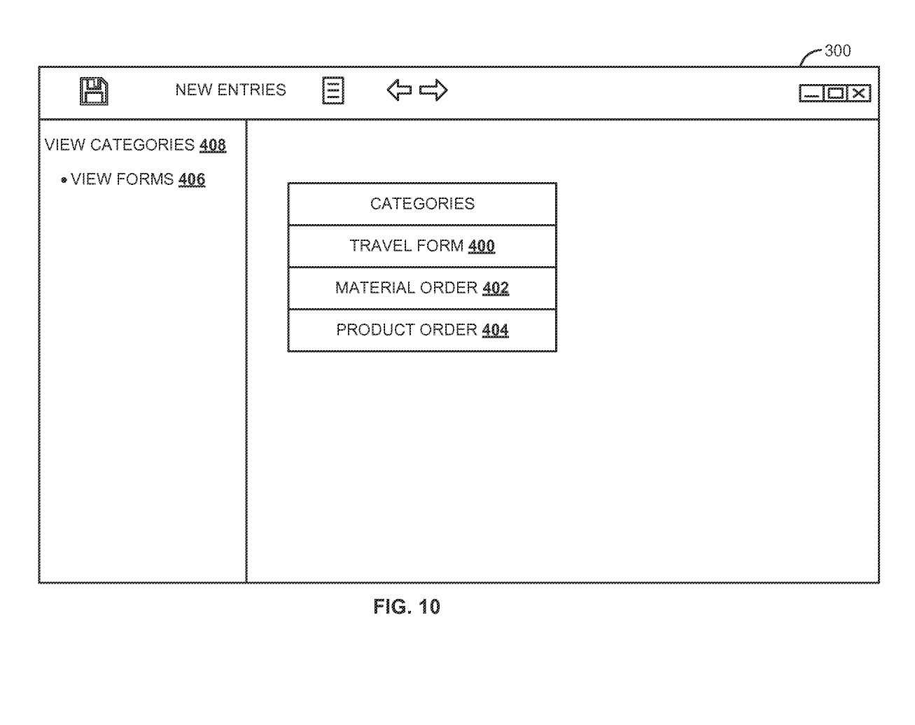

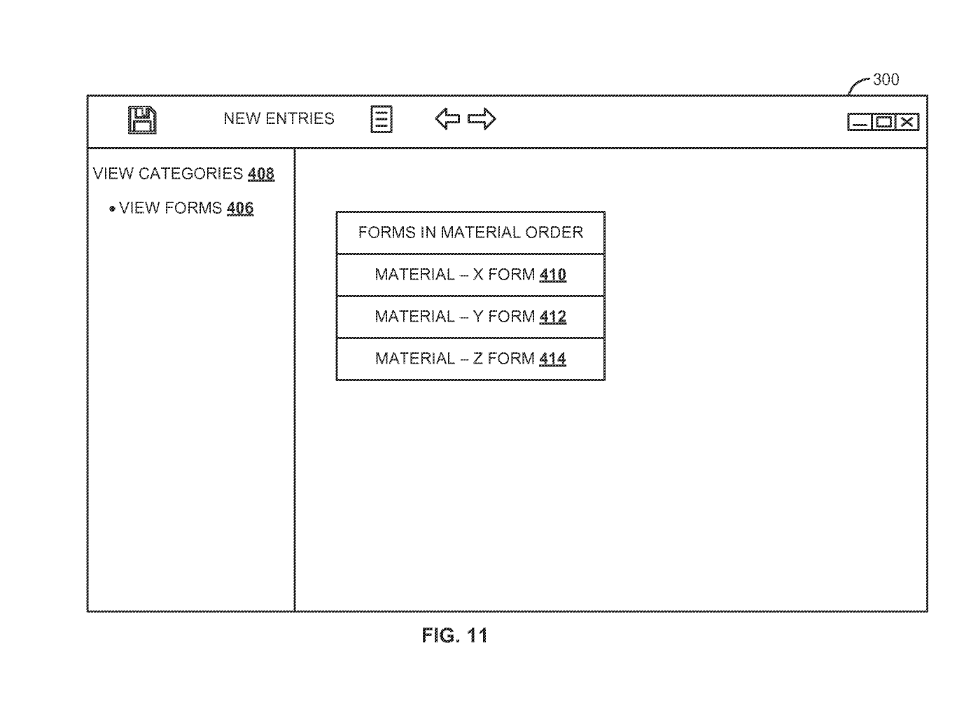

Referring to FIG. 10, the configuring user interface 300 can also be used to customize or modify an existing non-catalogue form. An existing non-catalogue form can be a form that is provided as standard as part of the SRM application or a previously configured form. A configuring user can select “view categories” option 408. Following, the categories of forms are displayed. Three categories, namely, travel form 400, material order 402, and product order 404 are displayed. As an example, the material order 402 can be selected. The option “view forms” can then be selected. Following which, the list of forms under the material order category is displayed, as shown in FIG. 11. In the material order category, there are three material order forms, namely, Material-X form 410, Material-Y form 412, and Material-Z form 414. Any of these forms can be selected for modification. Assume that Material-Y form 412 is selected.

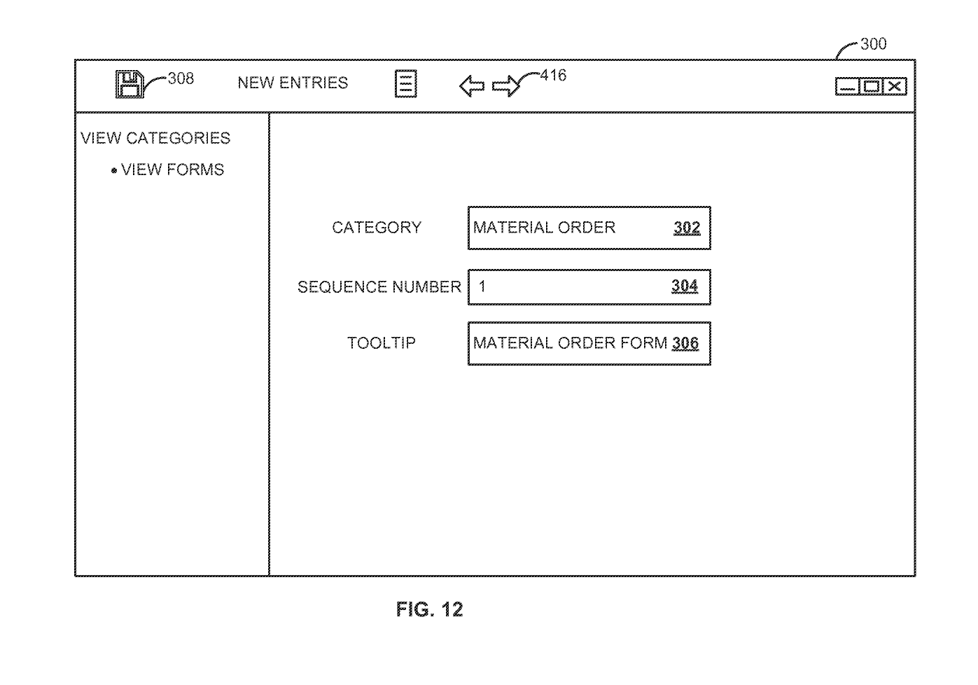

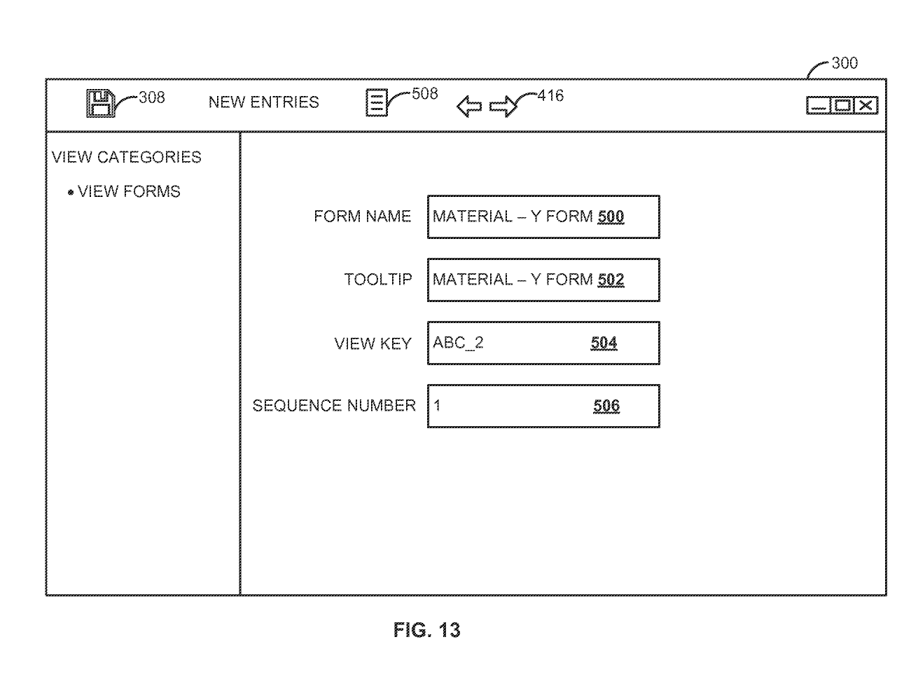

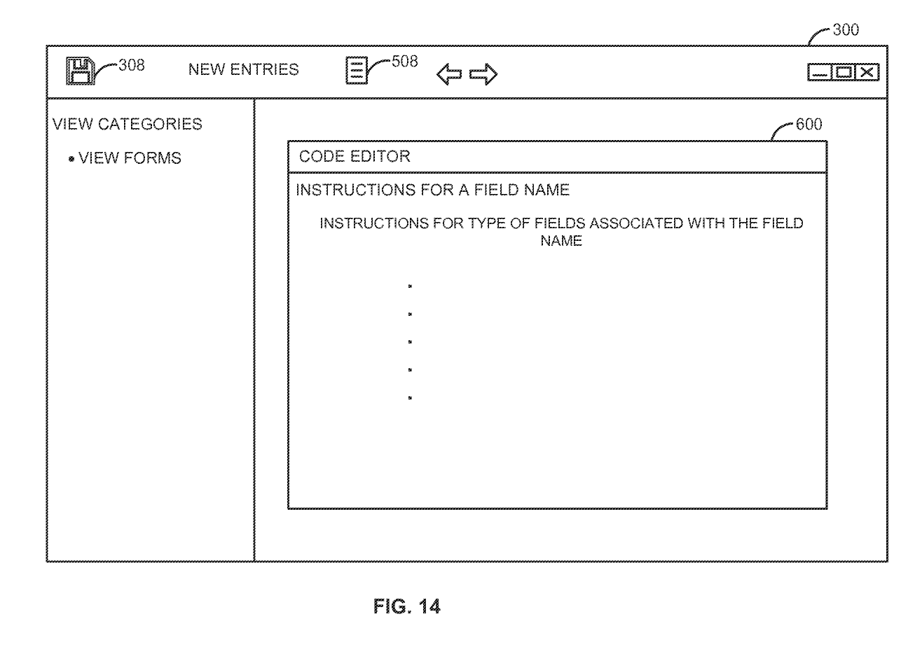

Referring to FIG. 12, after selecting Material-Y form, the first set of configuring fields 302, 304, and 306 are displayed in the right-side portion of the user interface 300. The entries in the first set of configuring fields 302, 304, and 306 are pre-populated based on previous configuration. These entries can be changed and saved, and a right arrow 416 can be selected. For example, the category of the form can be changed. If there is no change required, a right arrow 416 can be selected. Following selection of the right arrow 416, the second set of configuring fields 500, 507, 504, and 506 are displayed, as shown in FIG. 13. The entries in the second set of configuring fields 500-506 are pre-populated based on previous configuration. These entries can be changed and saved. For example, the name of the form can be changed. After the saving the changes in the second set of configuring fields 500-506 or if no changes are required, a code editor option 508 can be selected if the form fields are to be modified. The code editor 600 is then launched as shown in FIG. 14. The code editor 600 includes instructions that are previously configured. The configuring user can change the instructions to modify the name of an existing field, modify an existing limit field, modify an existing non-limit field, etc. The configuring user can also enter new instructions to add anew limit field, add a non-limit field, etc. The entries in the configuring fields and the instructions in the code editor 600 constitute modified configuration data. The modified configuration is received and saved by selecting the save option 508. This completes the modification of the “Material-Y” form.

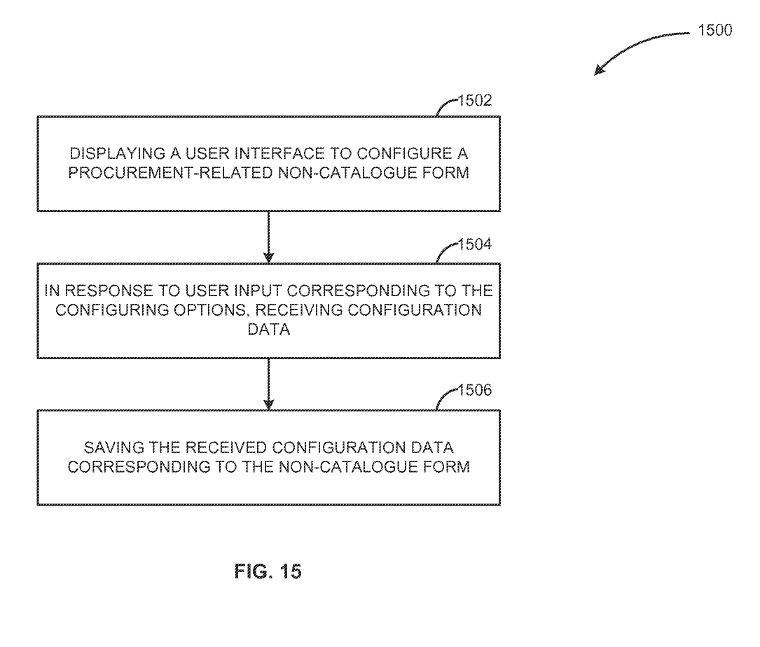

FIG. 15 illustrates a block diagram of an embodiment of a method of form design and display. At 1502, a user interface to configure a procurement-related non-catalogue form is displayed. The user interface includes configuring options that enable customization of form name, form category, and form fields. At 1504, configuration data is received in response to user input corresponding to the configuring options. At 1506, the received configuration data is saved corresponding to the non-catalogue form. The saved configuration data is read for rendering the non-catalogue form. For modifying an existing form or a previously configured form, the procedure is similar. The user interface to configure a form is displayed and modified configuration data is received in response to user input corresponding to the configuring options to modify the form. The modified configuration data is then saved.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

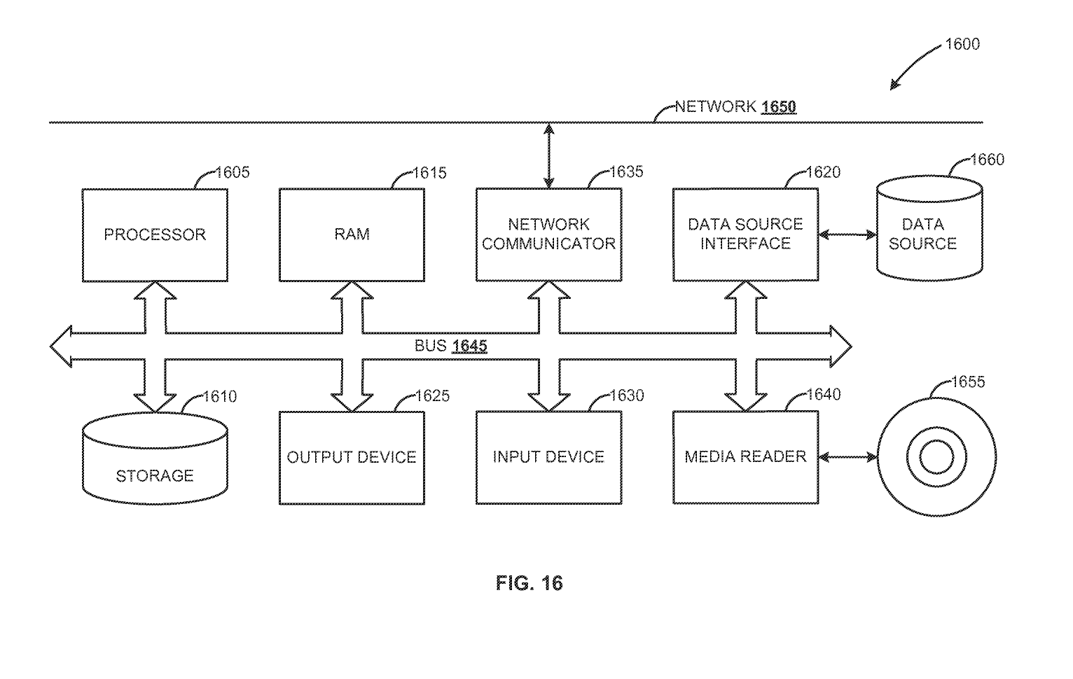

FIG. 16 is a block diagram of an exemplary computer system 1600. The computer system 1600 includes a processor 1605 that executes software instructions or code stored on a computer readable storage medium 1655 to perform the above-illustrated methods. The computer system 1600 includes a media reader 1640 to read the instructions from the computer readable storage medium 1655 and store the instructions in storage 1610 or in random access memory (RAM) 1615. The storage 1610 provides a large space for keeping static data where at least some instructions could be stored for later execution. The stored instructions may be further compiled to generate other representations of the instructions and dynamically stored in the RAM 1615. The processor 1605 reads instructions from the RAM 1615 and performs actions as instructed. According to one embodiment, the computer system 1600 further includes an output device 1625 (e.g., a display) to provide at least some of the results of the execution as output including, but not limited to, visual information to users and an input device 1630 to provide a user or another device with means for entering data and/or otherwise interact with the computer system 1600. Each of these output devices 1625 and input devices 1630 could be joined by one or more additional peripherals to further expand the capabilities of the computer system 1600. A network communicator 1635 may be provided to connect the computer system 1600 to a network 1650 and in turn to other devices connected to the network 1650 including other clients, servers, data stores, and interfaces, for instance. The modules of the computer system 1600 are interconnected via a bus 1645. Computer system 1600 includes a data source interface 1620 to access data source 1660. The data source 1660 can be accessed via one or more abstraction layers implemented in hardware Of software. For example, the data source 1660 may be accessed by network 1650. In some embodiments the data source 1660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may Occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer-implemented method of custom-form design and display, the method comprising:
displaying a user interface to configure a procurement-related non-catalogue form, wherein the user interface comprises configuring options enabling customization of form name, form category, and form fields;
in response to user input corresponding to the configuring options, receiving configuration data; and
saving the received configuration data corresponding to the non-catalogue form, wherein the saved configuration data is read for rendering the non-catalogue form.

2. The method of claim 1, wherein the configuring options comprise a code editor and configuring fields to name the non-catalogue form and assign a category to the non-catalogue form.

3. The method of claim 2, wherein the non-catalogue form comprises a limit order form and the configuration data for the limit order form comprise limit fields.

4. The method of claim 2, wherein fields of the non-catalogue form are configured in the code editor.

5. The method of claim 2, further comprising:
in response to user input corresponding to the configuring options to modify the non-catalogue form, receiving and saving modified configuration data.

6. The method of claim 5, wherein modifications of the non-catalogue form comprise one or more of:
changing the name of the non-catalogue form, changing the category of the non-catalogue form, adding new fields in the non-catalogue form, and changing existing fields of the non-catalogue form.

7. The method of claim 2, further comprising:
displaying a list of available forms in a procurement user interface, wherein the list of available forms are divided into categories; and
in response to a user action requesting the non-catalogue form, displaying the non-catalogue form including a plurality of input fields based on the configuration data.

8. A computer system for form design and display, comprising:
a computer memory to store program code; and
a processor to execute the program code to perform operations comprising:
displaying a user interface to configure a procurement-related non-catalogue form, wherein the user interface comprises configuring options enabling customization of form name, form category, and form fields;
in response to user input corresponding to the configuring options, receiving configuration data; and
saving the received configuration data corresponding to the non-catalogue form, wherein the saved configuration data is read for rendering the non-catalogue form.

9. The system of claim 8, wherein the configuring options comprise a code editor and configuring fields to name the non-catalogue form and assign a category to the non-catalogue form.

10. The system of claim 8, wherein the non-catalogue form comprises a limit order form and the configuration data for the limit order form comprise limit fields.

11. The system of claim 8, wherein fields of the non-catalogue form are configured in the code editor.

12. The system of claim 8, wherein the operations fisher comprising:
in response to user input corresponding to the configuring options to modify the non-catalogue form, receiving and saving modified configuration data.

13. The system of claim 12, wherein modifications of the non-catalogue form comprise one or more of:
changing the name of the non-catalogue form, changing the category of the non-catalogue form, adding new fields in the non-catalogue form, and changing existing fields of the non-catalogue form.

14. The system of claim 8, wherein the operations further comprising:
displaying a list of available forms in a procurement user interface, wherein the list of available forms are divided into categories; and
in response to a user action requesting the non-catalogue form, displaying the non-catalogue form including a plurality of input fields based on the configuration data.

15. An article of manufacture including a non-transitory computer readable storage medium to tangibly store instructions, which when executed by a computer, cause the computer to perform operations comprising:
displaying a user interface to configure a procurement-related non-catalogue form, wherein the user interface comprises configuring options enabling customization of form name, form category, and form fields;
in response to user input corresponding to the configuring options, receiving configuration data; and
saving the received configuration data corresponding to the non-catalogue form, wherein the saved configuration data is read for rendering the non-catalogue form.

16. The article of manufacture of claim 15, wherein the configuring options comprise a code editor and configuring fields to name the non-catalogue form and assign a category to the non-catalogue form.

17. The article of manufacture of claim 16, wherein the non-catalogue form comprises a limit order form and the configuration data for the limit order form comprise limit fields.

18. The article of manufacture of claim 16, wherein fields of the non-catalogue form are configured in the code editor.

19. The article of manufacture of claim 16, wherein the operations further comprising:
in response to user input corresponding to the configuring options to modify the non-catalogue form, receiving and saving modified configuration data, wherein modifications of the non-catalogue form comprise one or more of: changing the name of the non-catalogue form, changing the category of the non-catalogue form, adding new fields in the non-catalogue form, and changing existing fields of the non-catalogue form.

20. The article of manufacture of claim 1, wherein the operations further comprising:
displaying a list of available forms in a procurement user interface, wherein the list of available, forms are divided into categories; and
in response to a user action requesting the non-catalogue form, displaying the non-catalogue form including a plurality of input fields based on the configuration data.
